(19) United States
(12) Patent Application Publication
(10) Pub. No.: US 2026/0239295 A1
(43) Pub. Date: Aug. 13, 2026

(54) BEAM-SELECTIVE PAGING MESSAGE TRANSMISSION

(71) Applicant: QUALCOMM Incorporated, San Diego, CA (US)

(72) Inventors: Wooseok NAM, San Diego, CA (US); Jelena DAMNJANOVIC, Del Mar, CA (US); Navid ABEDINI, Basking Ridge, NJ (US); Junyi LI, Greentown, PA (US); Tao LUO, San Diego, CA (US)

(21) Appl. No.: 19/419,974

(22) Filed: Dec. 15, 2025

Related U.S. Application Data
(60) Provisional application No. 63/755,807, filed on Feb. 7, 2025.

(51) Int. Cl. H04W 68/02; H04B 7/06

(52) U.S. Cl. CPC H04W 68/02; H04B 7/06952

(57) ABSTRACT

Methods, systems, and devices for wireless communications are described. Techniques described herein may enable a network entity and a user equipment (UE) to determine a beam via which the UE may monitor for a paging message. The network entity may accordingly refrain from repeating the paging message via multiple beams. For example, the network entity may transmit a paging early indication (PEI) message that is statically associated with a synchronization signal block (SSB) group of the UE. The PEI may indicate resources (e.g., monitoring occasions within a paging occasion, beams) via which the UE may monitor for the paging message. The monitoring occasions may therefore be dynamically associated with a respective SSB.

### CROSS REFERENCE

The present Application for Patent claims benefit of U.S. Provisional Patent Application No. 63/755,807 by NAM et al., entitled “BEAM-SELECTIVE PAGING MESSAGE TRANSMISSION,” filed Feb. 7, 2025, assigned to the assignee hereof, and expressly incorporated by reference herein.

### FIELD OF TECHNOLOGY

The following relates to wireless communications, including beam-selective paging message transmission.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a network entity is described. The method may include outputting, to a first user equipment (UE), a synchronization signal block (SSB) indicating for the UE to monitor a first transmission beam associated with a first paging early indication (PEI) message, where the first PEI message is different from one or more second PEI messages associated with one or more second transmission beams, outputting, via the first transmission beam, the first PEI message, where the first PEI message indicates a first monitoring occasion (MO) of a paging occasion associated with a first paging message, and outputting, via the first MO, the first paging message in accordance with the first PEI message.

A network entity for wireless communications is described. The network entity may include one or more memories storing processor executable code, and one or more processors coupled with the one or more memories. The one or more processors may individually or collectively be operable to execute the code to cause the network entity to output, to a first UE, a SSB indicating for the UE to monitor a first transmission beam associated with a first PEI message, where the first PEI message is different from one or more second PEI messages associated with one or more second transmission beams, output, via the first transmission beam, the first PEI message, where the first PEI message indicates a first MO of a paging occasion associated with a first paging message, and output, via the first MO, the first paging message in accordance with the first PEI message.

Another network entity for wireless communications is described. The network entity may include means for outputting, to a first UE, a SSB indicating for the UE to monitor a first transmission beam associated with a first PEI message, where the first PEI message is different from one or more second PEI messages associated with one or more second transmission beams, means for outputting, via the first transmission beam, the first PEI message, where the first PEI message indicates a first MO of a paging occasion associated with a first paging message, and means for outputting, via the first MO, the first paging message in accordance with the first PEI message.

A non-transitory computer-readable medium storing code for wireless communications is described. The code may include instructions executable by one or more processors to output, to a first UE, a SSB indicating for the UE to monitor a first transmission beam associated with a first PEI message, where the first PEI message is different from one or more second PEI messages associated with one or more second transmission beams, output, via the first transmission beam, the first PEI message, where the first PEI message indicates a first MO of a paging occasion associated with a first paging message, and output, via the first MO, the first paging message in accordance with the first PEI message.

Some examples of the method, network entities, and non-transitory computer-readable medium described herein may further include operations, features, means, or instructions for outputting, to the UE, first control signaling indicating a location of the first MO in the paging occasion, where outputting the first paging message may be in accordance with the first control signaling.

Some examples of the method, network entities, and non-transitory computer-readable medium described herein may further include operations, features, means, or instructions for obtaining, from the UE, a capability message that indicates a first type of the UE and outputting, to the UE, second control signaling indicating that the paging occasion, the first MO, or both may be associated with the first type of the UE, where a second paging occasion, a second MO, or both may be associated with a second type.

Some examples of the method, network entities, and non-transitory computer-readable medium described herein may further include operations, features, means, or instructions for outputting, to the UE, third control signaling indicating for the UE to monitor resources associated with the first type, the second type, or both based on the capability message.

Some examples of the method, network entities, and non-transitory computer-readable medium described herein may further include operations, features, means, or instructions for obtaining, from the UE, signaling indicating a preference of the UE to monitor resources associated with the first type, the second type, or both.

In some examples of the method, network entities, and non-transitory computer-readable medium described herein, the first MO may be dynamically associated with the SSB based on the first PEI message.

In some examples of the method, network entities, and non-transitory computer-readable medium described herein, one or more additional MOs of the paging occasion may be not associated with one or more additional paging messages.

In some examples of the method, network entities, and non-transitory computer-readable medium described herein, the first MO occurs earlier in time than the one or more additional MOs of the paging occasion.

In some examples of the method, network entities, and non-transitory computer-readable medium described herein, the paging occasion may be dynamically indicated via the first PEI message.

In some examples of the method, network entities, and non-transitory computer-readable medium described herein, the indication of the first MO includes an implicit indication based on a paging subgroup associated with the UE and a quantity of MOs indicated via the first PEI message.

In some examples of the method, network entities, and non-transitory computer-readable medium described herein, the indication of the first MO includes an explicit indication based on a MO offset value indicated via the first PEI message.

In some examples of the method, network entities, and non-transitory computer-readable medium described herein, the MO offset value may be associated with a paging subgroup associated with the UE and a quantity of MOs indicated via the first PEI message.

In some examples of the method, network entities, and non-transitory computer-readable medium described herein, the first MO occurs earlier in time than one or more additional MOs of the paging occasion that may be not associated with one or more additional paging messages based on the MO offset value.

In some examples of the method, network entities, and non-transitory computer-readable medium described herein, the first PEI message indicates an aggregation level associated with the first paging message, a position of a paging search space set associated with the first paging message, beam associated with the first paging message, a quasi co-location assumption associated with the first paging message, a quantity of repetitions associated with the first paging message, an associated SSB identifier associated with the first paging message, or any combination thereof.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports beam-selective paging message transmission in accordance with one or more aspects of the present disclosure.

FIG. 2 shows an example of a wireless communications system that supports beam-selective paging message transmission in accordance with one or more aspects of the present disclosure.

FIG. 3 shows an example of a timing diagram that supports beam-selective paging message transmission in accordance with one or more aspects of the present disclosure.

FIG. 4 shows an example of a timing diagram that supports beam-selective paging message transmission in accordance with one or more aspects of the present disclosure.

FIG. 5 shows an example of a process flow that supports beam-selective paging message transmission in accordance with one or more aspects of the present disclosure.

FIGS. 6 and 7 show block diagrams of devices that support beam-selective paging message transmission in accordance with one or more aspects of the present disclosure.

FIG. 8 shows a block diagram of a communications manager that supports beam-selective paging message transmission in accordance with one or more aspects of the present disclosure.

FIG. 9 shows a diagram of a system including a device that supports beam-selective paging message transmission in accordance with one or more aspects of the present disclosure.

FIG. 10 shows a flowchart illustrating methods that support beam-selective paging message transmission in accordance with one or more aspects of the present disclosure.

### DETAILED DESCRIPTION

In some wireless communications systems, a user equipment (UE) may monitor for a paging message from a network entity. In some examples, the network entity may transmit the paging message via a set of beams and the UE may select a beam via which to monitor for the paging message. Such techniques may reduce power consumption at the UE. However, the network entity may repeat a same paging message over multiple unused beams, which may increase power consumption of the network entity.

Accordingly, techniques described herein may enable the network entity and the UE to determine a beam via which the UE may monitor for the paging message. The network entity may accordingly refrain from repeating the paging message via multiple beams, which may decrease power consumption. For example, the network entity may transmit a paging early indication (PEI) message that is statically associated with a synchronization signal block (SSB) group of the UE that indicates resources (e.g., monitoring occasions (MOs) within a paging occasion (PO), beams) via which the UE may monitor for the paging message. The MOs may therefore be dynamically associated with a respective SSB, which may enable relatively more flexible transmission of paging messages and may reduce power consumption by the network entity.

Aspects of the disclosure are initially described in the context of wireless communications systems. Aspects of the disclosure are further illustrated by and described with reference to timing diagrams, process flows, apparatus diagrams, system diagrams, and flowcharts that relate to beam-selective paging message transmission.

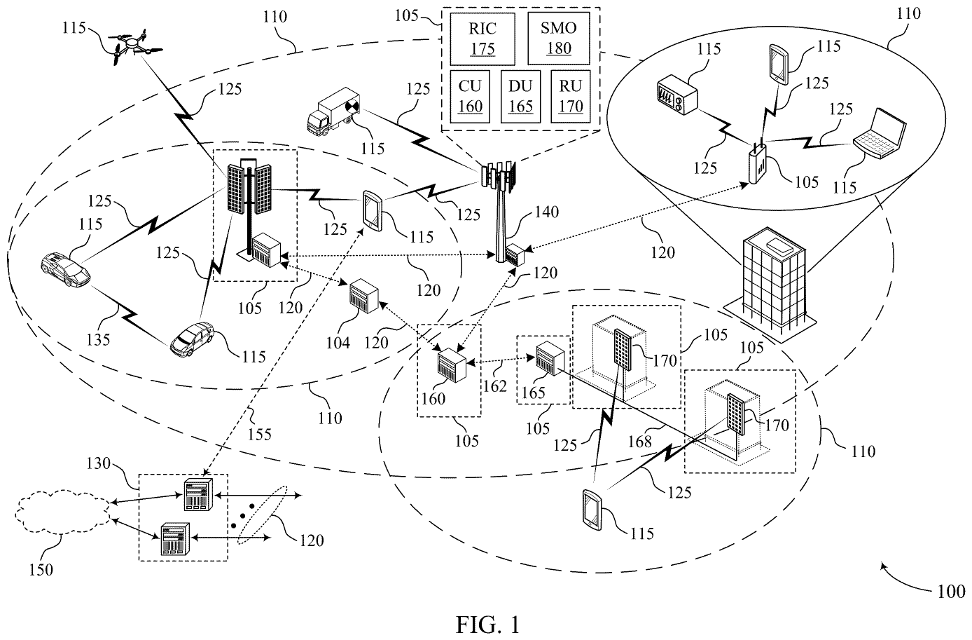

FIG. 1 shows an example of a wireless communications system 100 that supports beam-selective paging message transmission in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support beam-selective paging message transmission as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some examples of the wireless communications system 100, a network entity 105 and a UE 115 may determine a beam via which the UE 115 may monitor for a paging message. The network entity 105 may accordingly refrain from repeating the paging message via multiple beams, which may decrease power consumption. For example, the network entity may transmit a PEI message that is statically associated with a SSB group of the UE 115 that indicates resources (e.g., MOs within a PO, beams) via which the UE 115 may monitor for the paging message. The MOs may therefore be dynamically associated with a respective SSB.

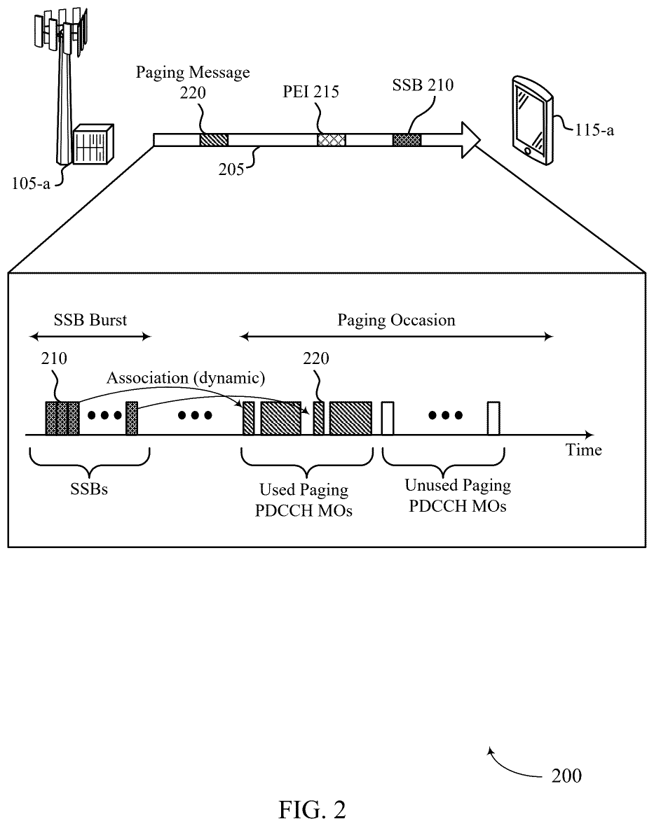

FIG. 2 shows an example of a wireless communications system 200 that supports beam-selective paging message transmission in accordance with one or more aspects of the present disclosure. The wireless communications system 200 may implement or may be implemented by aspects of the wireless communications system 100. For example, the wireless communications system 200 may be implemented by a UE 115 (e.g., a UE 115-a) or a network entity 105 (e.g., a network entity 105-a), which may be examples of the corresponding devices as described with reference to FIG. 1.

In some examples of the wireless communications system 200, a network entity 105-a may output one or more paging messages 220 to a UE 115-a via a channel 205. Each paging message 220 (e.g., a physical downlink control channel (PDCCH) or physical downlink shared channel (PDSCH) transmission in PO (PO) or paging frame (PF)) may be associated with an SSB 210. Paging messages 220 (e.g., PDCCH and PDSCH) may be transmitted using the same beam as the SSB (e.g., up to 64 beams in FR2).

In some examples, the network entity 105-a may not know the best (e.g., highest-quality) beam for the UE 115-a (e.g., in RRC idle or inactive mode). Accordingly, the network entity 105-a may transmit paging PDCCH/PDSCHs with beam sweeping. The UE 115 115-a may choose the best beam to receive paging based on measurements of the SSB. In multi-beam operations, the UE 115-a may assume that the same paging message and the same short message are repeated in all transmitted beams, and thus the selection of the beam(s) for the reception of the paging message 220 and short message is up to UE implementation. The paging message may be the same for both RAN-initiated paging and CN-initiated paging.

In some examples, a PO may be shared by a group of UEs 115. Accordingly, paging PDCCH and PDSCH may be transmitted if at least one UE 115 in the group is paged. When a paging PDCCH is detected, a UE 115-a may not know whether the paging is intended for the UE 115-a or other UEs 115 in the same group before decoding the paging message (e.g., decoding the PDSCH). If the paging is not addressed to the UE 115-a, the UE 115-a may increase power consumption by decoding a message for another UE 115.

Accordingly, the UEs 115 may be allocated to subgroups. For example, UEs 115 associated with the same PO may be split into smaller subgroups, which may enable more granular paging indications and reduce power consumption of the UE 115-a. In some examples, the network entity 105-a may output a PEI 215 (e.g., before the PO of the UEs 115) that may indicate whether the subgroup will be paged or not.

The UE 115-a may first monitor for the PEI 215 in PEI MOs. If the UE 115-a detects a PEI 215 and a bitmap in the PEI 215 indicates that the UE's corresponding PO and subgroup will be paged, the UE 115-a may proceed with monitoring for paging messages 220 (e.g., PDCCH/PDSCH reception) in the PO. Accordingly, the chance of unnecessary paging PDCCH/PDSCH decoding may be reduced. Such techniques may enable UE energy savings. However, these techniques may increase energy consumption of network entities 105 due to an additional burden of PEI transmission.

In some examples, network energy saving (NES) schemes have introduced techniques (e.g., cell discontinuous transmission (DTX) and discontinuous reception (DRX), number of antennas/transmission power adaptation, on-demand SSB/system information block (SIB)1, etc.) that may decrease energy consumption of the network entity 105-a. In some examples, new use cases and/or device types may allow further energy-efficient optimization of paging, such as static UEs 115 with known Tx beam direction (e.g., fixed wireless access (FWA) UEs 115), mobile UEs 115 with known positions/beams (e.g., high-speed trains (HST), automated guided vehicles (AGV)), or advanced idle/inactive UEs 115 with position/beam-tracking based on artificial intelligence or machine learning.

Aspects described herein may enable paging enhancements for network-side energy saving. For example, the network entity 105-a may not repeat the same paging message and/or the same Short Message in all transmitted beams. The network entity 105-a may transmit one or more different paging messages via at least some of the transmitted beams. Within a PO, there may not be a fixed association between an SSB 210 and a paging PDCCH MO. That is, an association between an SSB 210 and a paging message 220 in MO may be dynamic. Hence, a transmission beam for paging PDCCH/PDSCH may not be pre-determined for a given occasion.

Such techniques may apply for cases in which the paging PDCCH MO or search space set (SSS) (e.g., a Type 2 SSS) may be different from those for system information (e.g., a Type 0 SSS). Additionally, there may not be a fixed or static association between PFs or POs and a UE index. For example, the PEI 215 (e.g., if configured) may dynamically indicate the PF or PO for the UE.

A paging PDCCH or Short Message may be transmitted on a subset of PDCCH MOs within the PO. The first transmission may start from the first paging PDCCH MO in the PO. Additionally, or alternatively, the first actual transmission occasion may be pre-determined (e.g., by RRC or system information) or dynamically indicated by the PEI 215. The paging PDCCHs and/or Short Messages may be consecutively transmitted in the PO or PF. Paging message(s) and/or Short Message(s) for this consecutive transmissions may be the same (e.g., repetition) or different, (e.g., beam-specific paging message transmission), or a combination thereof.

By transmitting paging messages consecutively (e.g., back-to-back transmission), the network entity 105-a may reduce the active time and therefore reduce energy consumption. PFs, POs and/or paging PDCCH MOs within the PO for this beam-selective paging may be separately provided from the other paging resources (e.g., fixed association with SSB and repetition of same paging message). The paging resource may dedicatedly be used by some specific type of UEs or devices, a specific capability, and/or a specific use case (e.g., FWA).

The network entity 105-a may indicate the UE 115-a to use one or both of beam-selective or non-beam selective paging resources. This can be indicated when the UE 115-a is connected to the network entity 105-a (e.g., through MAC control element (CE) or RRC), when the connection is released (e.g., through an RRC release message), or while the UE 115-a is in RRC idle mode (e.g., through downlink small data transmissions (SDT)). Alternatively, the UE 115-a may autonomously select which resource to use (e.g., depending on event(s), such as speed felling below a threshold)

Optionally, the UE 115-a (e.g., while in an RRC idle/inactive mode) may indicate a position or preferred paging beam (e.g., a preferred SSB index, PF, or PO) to the network entity 105-a (e.g., when there are any changes in the position or preferred paging beam). The UE 115-a may indicate the position or preferred paging beam via an uplink SDT procedure. In some examples, beam-selective and non-beam selective paging resources may be multiplexed in different domains. For example, in the time-domain, the beam-selective and non-beam selective paging resources may be staggered in time. In the frequency-domain, beam-selective and non-beam selective paging resources may use different frequency resources. In the spatial-domain, some transmission beams (e.g., SSBs) may be used for beam-selective or non-beam selective paging resources, or both.

In some examples, if the PEI 215 for beam-selective paging is configured, the PEI 215 may be transmitted in pre-determined occasions with pre-determined beams. For example, there may be a fixed or static association between PEI MOs or transmission beams and SSBs. The SSBs may comprise an entire SSB burst set, or a subset of the entire set of on-demand (e.g., partial SSB transmission) may be applied.

In some examples, the same PEI 215 may not be repeated in all transmitted beams. That is, the network entity 105-a may output a beam-specific PEI 215. In some examples, there may be different PEI payloads for different transmission beams.

In some examples, extra network energy consumption by PEI transmission can be reduced by aligning the PEI transmission with the SSB transmission. For example, frequency-domain modulation (FDM) (e.g., SSB-CORESET multiplexing patterns 2 and 3) or back-to-back time-domain modulation (TDM) of PEI and SSB may be used. A PEI for beam-selective paging may deliver information for monitoring beam-selective paging. Additionally, or alternatively, the PEI 215 payload may include POs to be paged, UE subgroups, position of PF and PO within a paging cycle, position of paging PDCCH MO (e.g., offset from the first MO) in the PO, paging PDCCH aggregation level and position in the paging search space set (e.g., to reduce blind decoding), beam or quasi co-location (QCL) assumption, an associated SSB identifier (ID) of the paging PDCCH/PDSCH and/or Short Message transmission, and/or a quantity of repetitions of the paging PDCCH/PDSCH and/or Short Message transmissions (e.g., overall or per-beam).

If both beam-selective and non-beam selective paging is used, PEI MOs for beam-selective paging may be separated from or shared with the non-beam selective PEI MOs. Within a PEI payload, beam-selective and non-beam selective paging may be assigned with separate fields. Additionally, or alternatively, within a PEI field, beam-selective and non-beam selective paging UEs 115 may be assigned with separate subgroup indices. Additionally, or alternatively, beam-selective and non-beam selective paging resources may have different PEI formats and/or PEI-RNTIs.

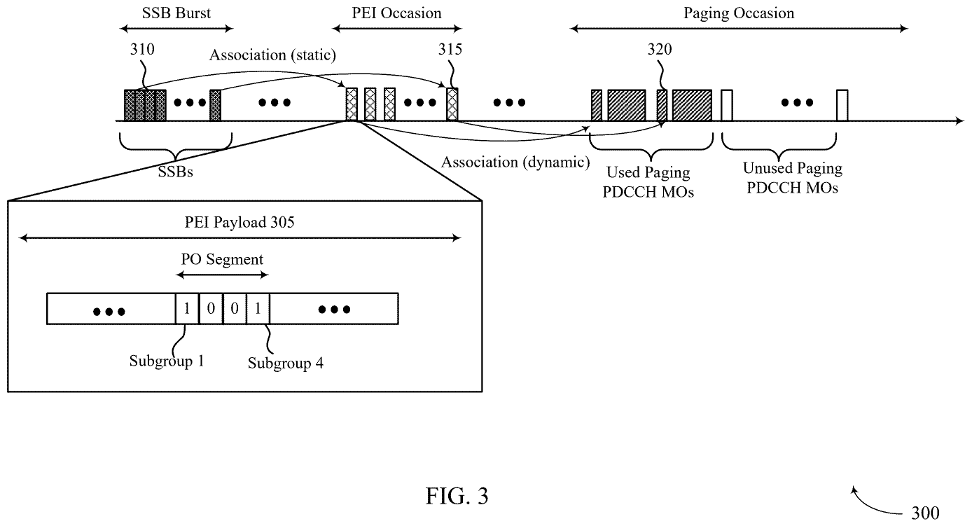

FIG. 3 shows an example of a timing diagram 300 that supports beam-selective paging message transmission in accordance with one or more aspects of the present disclosure. The timing diagram 300 may implement or may be implemented by aspects of the wireless communications system 100 or the wireless communications system 200. For example, the timing diagram 300 may be implemented by a UE 115 or a network entity 105, which may be examples of the corresponding devices as described with reference to FIG. 1.

In some examples, as described with reference to FIG. 2, a network entity 105 may transmit beam-specific paging messages 320 to one or more UEs 115. In some examples, an association between an SSB 310 and a PO for a paging message 320 may be dynamic. In some cases, an association between the SSB 310 and a PEI 315 may be static, and an association between the PEI 315 and the PO may be dynamic.

In some examples, a PEI 315 may explicitly or implicitly indicate PDCCH MOs. For example, two UEs 115 may be in paging subgroups with known paging transmission beams (e.g., a first FWA UE in paging subgroup 1 with beam 1, and a second FWA UE in paging subgroup 4 with beam S). For implicit paging PDCCH MO determination, a payload 305 of the PEI 315 may implicitly indicate a MO to each UE. As an illustrative example, for the first FWA UE, a first ‘1’ in the PEI payload 305 (e.g., which may be in a location indicative of subgroup 1) may indicate that a first paging PDCCH MO in the PO will be transmitted with beam 1. For the second FWA UE, a second ‘1’ in the PEI (e.g., which may be in a location indicative of subgroup 4) may indicate that a second paging PDCCH MO in the PO will be transmitted with beam S.

In such examples, a quantity of previous ‘1’s in the PEI payload may indicate a location of the MO in the PO. For example, a sequentially first ‘1’ may indicate that the respective PDCCH MO will be transmitted in the sequentially first MO of the PO, and so on. The PEI 315 may accordingly dynamically indicate a MO for a UE 115 to monitor for a paging message 320.

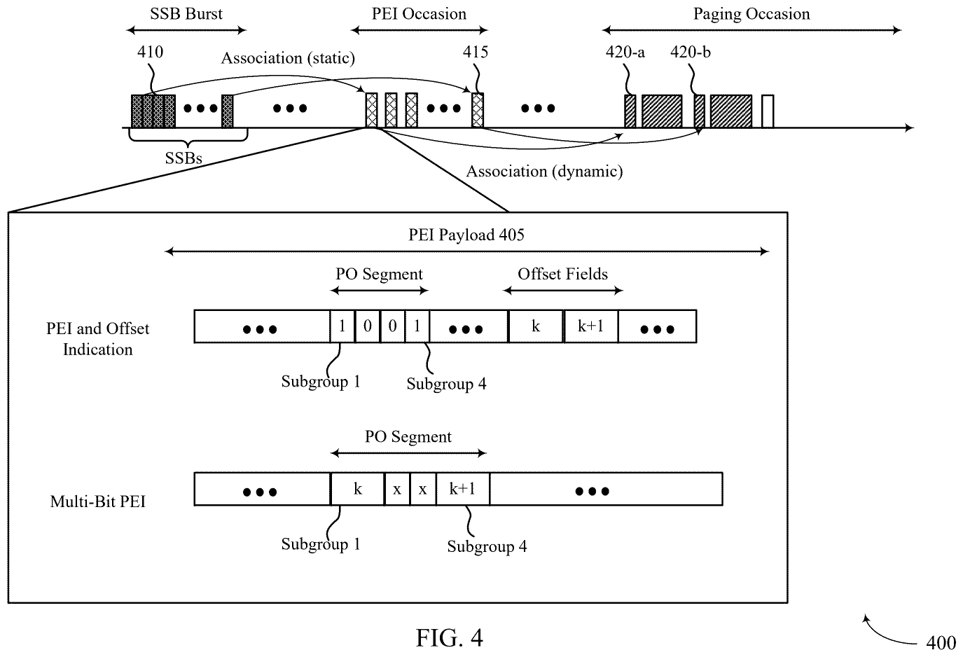

FIG. 4 shows an example of a timing diagram 400 that supports beam-selective paging message transmission in accordance with one or more aspects of the present disclosure. The timing diagram 400 may implement or may be implemented by aspects of the wireless communications system 100, the wireless communications system 200, or the timing diagram 300. For example, the timing diagram 400 may be implemented by a UE 115 or a network entity 105, which may be examples of the corresponding devices as described with reference to FIG. 1.

In some examples, as described with reference to FIG. 2, a network entity 105 may transmit beam-specific paging messages 420 to one or more UEs 115. In some examples, an association between an SSB 410 and a PO for a paging message 420 may be dynamic. In some cases, an association between the SSB 410 and a PEI 415 may be static, and an association between the PEI 415 and the PO may be dynamic.

In some examples, a PEI may explicitly or implicitly indicate PDCCH MOs. For example, two UEs 115 may be in paging subgroups with known paging transmission beams (e.g., a first FWA UE in paging subgroup 1 with beam 1, and a second FWA UE in paging subgroup 4 with beam S). As an illustrative example, for explicit paging PDCCH MO determination, for the first FWA UE, the PEI payload 405 may indicate an offset value k for subgroup 1. The offset value k may indicate that the k-th paging PDCCH MO in the PO associated with beam 1 may be used to transmit a paging message 420-a for the first UE. An offset value (k+1) indicated by the PEI payload 405 for subgroup 4 may indicate that the (k+1)-th paging PDCCH MO in the PO with beam S may be used to transmit a paging message 420-b for the second UE.

In some examples, the PEI payload 405 may include a first set of bits indicating whether a paging message may be transmitted to each subgroup, and a second set of bits indicating an offset associated with each subgroup. In such examples, the offset associated with each subgroup may be based on a quantity of subgroups that are indicated to receive a paging message. For example, a sequentially first ‘1’ may indicate that the respective PDCCH MO will be transmitted according to a sequentially first offset indicated by the PO, and so on. Additionally, or alternatively, a multi-bit PEI payload 405 may include a quantity of bits that jointly indicates that a paging message will be transmitted to a respective subgroup by indicating the offset, or that indicates that a paging message will not be transmitted to a respective subgroup by not indicating an offset (e.g., indicating a null value, such as x).

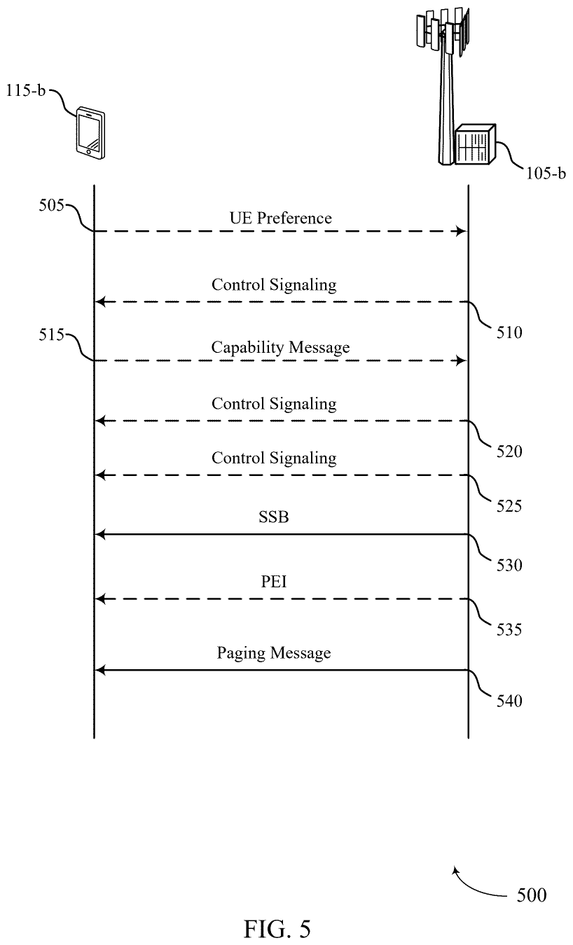

FIG. 5 shows an example of a process flow 500 that supports beam-selective paging message transmission in accordance with one or more aspects of the present disclosure. The process flow 500 may implement or may be implemented by aspects of the wireless communications system 100, the wireless communications system 200, the timing diagram 300, or the timing diagram 400. For example, the process flow 500 may be implemented by a UE 115 (e.g., a UE 115-b) or a network entity 105 (e.g., a network entity 105-b), which may be examples of the corresponding devices as described with reference to FIG. 1.

In the following description of the process flow 500, the operations between the UE 115-b and the network entity 105-b may occur in a different order than the example order shown and, in some examples, may be performed by one or more different devices other than those shown as examples. Some operations also may be omitted from the process flow 500, and other operations may be added to the process flow 500. Further, although some operations or signaling may be shown to occur at different times for discussion purposes, these operations may actually occur at the same time.

In some examples, at 505, the UE 115-b may output signaling indicating a preference of the UE 115-b to monitor resources associated with a first type (e.g., a type of the UE 115-b), a second type, or both. In some examples, the resources associated with the first type may be beam-selective paging resources and the resources associated with the second type may be non-beam selective paging resources.

In some examples, at 510, the UE 115-b may receive first control signaling from the network entity 105-b indicating a location of a first MO in a PO. In some examples, at 515, the UE 115-b may transmit a capability message to the network entity 105-b indicating a type of the UE 115-b. In some examples, at 520, the UE 115-b may receive second control signaling from the network entity 105-b indicating that the PO, the MO, or both are associated with the type of the UE 115-b (e.g., and/or that one or more other POs or MOs are associated with a different type of UE 115). In some examples, at 525, the UE 115-b may receive third control signaling from the network entity 105-b indicating for the UE 115-b to monitor resources associated with the first type, the second type, or both.

At 530, the network entity 105-b may output an SSB indicating for the UE 115-b to monitor a first transmission beam associated with a first PEI message. The first PEI message may be different from one or more second PEI messages associated with one or more second transmission beams.

At 535, the network entity 105-b may output the PEI message via the first transmission beam. The first PEI message may indicate the first MO of the PO for a first paging message for the UE 115-b. The first MO may be dynamically associated with the SSB based on the PEI. In some examples, one or more additional MOs of the PO may not be associated with paging messages. In some examples, the first MO may be sequentially before the MOs that are not associated with paging messages or may be sequentially after one or more of the MOs that are not associated with paging messages (e.g., based on an offset indicated by the PEI).

In some examples, the PO may be dynamically indicated by the PEI. In some examples, the indication of the MO may be implicit based on a paging subgroup associated with the UE 115-b and a quantity of MOs indicated via the first PEI message. In some examples, the indication of the MO may be explicit based on an offset indicated via the first PEI message (e.g., and/or based on the paging subgroup associated with the UE 115-b and the quantity of MOs indicated via the first PEI message).

At 540, the network entity 105-b may output the paging message to the UE 115-b in accordance with the indication of the MO in the PEI message, in accordance with the capability and/or preference of the UE 115-b, in accordance with the control signaling, or any combination thereof.

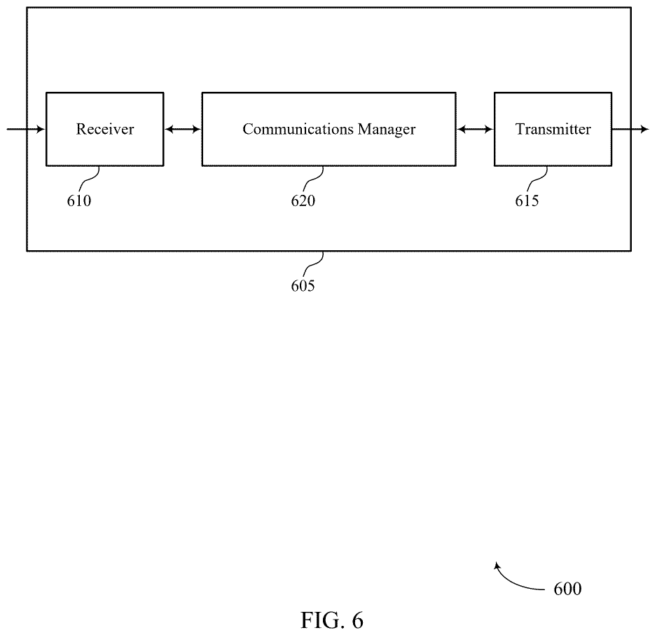

FIG. 6 shows a block diagram 600 of a device 605 that supports beam-selective paging message transmission in accordance with one or more aspects of the present disclosure. The device 605 may be an example of aspects of a network entity 105 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to, individually or collectively, support or enable the described techniques. Each of these components may be in communication with one another (e.g., via one or more buses).

The receiver 610 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 605. In some examples, the receiver 610 may support obtaining information by receiving signals via one or more antennas. Additionally, or alternatively, the receiver 610 may support obtaining information by receiving signals via one or more wired (e.g., electrical, fiber optic) interfaces, wireless interfaces, or any combination thereof.

The transmitter 615 may provide a means for outputting (e.g., transmitting, providing, conveying, sending) information generated by other components of the device 605. For example, the transmitter 615 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 615 may support outputting information by transmitting signals via one or more antennas. Additionally, or alternatively, the transmitter 615 may support outputting information by transmitting signals via one or more wired (e.g., electrical, fiber optic) interfaces, wireless interfaces, or any combination thereof. In some examples, the transmitter 615 and the receiver 610 may be co-located in a transceiver, which may include or be coupled with a modem.

The communications manager 620, the receiver 610, the transmitter 615, or various combinations or components thereof may be examples of means for performing various aspects of beam-selective paging message transmission as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor (e.g., referred to as a processor-executable code). If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. For example, the communications manager 620 is capable of, configured to, or operable to support a means for outputting, to a first UE, a synchronization signal block indicating for the UE to monitor a first transmission beam associated with a first paging early indication message, where the first paging early indication message is different from one or more second paging early indication messages associated with one or more second transmission beams. The communications manager 620 is capable of, configured to, or operable to support a means for outputting, via the first transmission beam, the first paging early indication message, where the first paging early indication message indicates a first MO of a PO associated with a first paging message. The communications manager 620 is capable of, configured to, or operable to support a means for outputting, via the first MO, the first paging message in accordance with the first paging early indication message.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for dynamically associating paging resources with a paging message, which may enable reduced power consumption and more efficient utilization of communication resources.

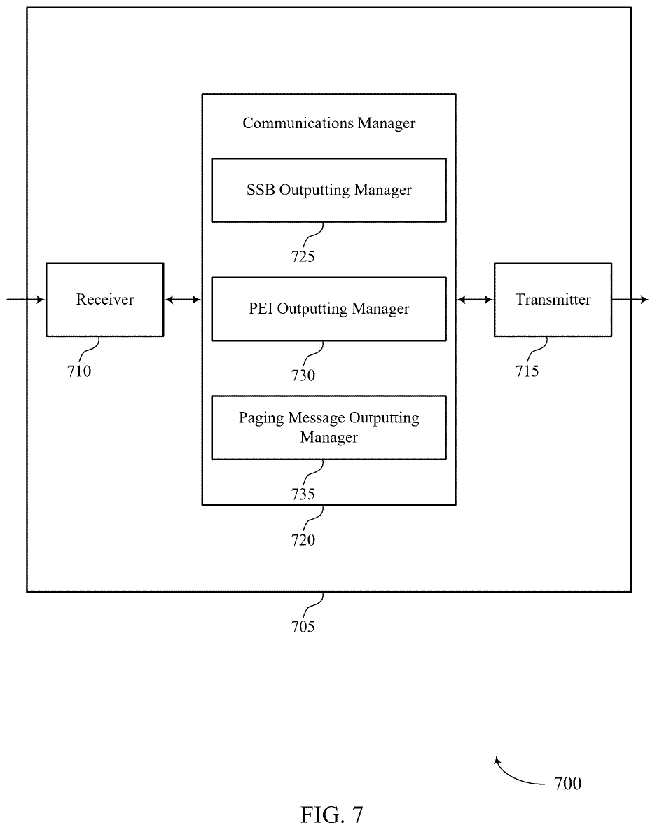

FIG. 7 shows a block diagram 700 of a device 705 that supports beam-selective paging message transmission in accordance with one or more aspects of the present disclosure. The device 705 may be an example of aspects of a device 605 or a network entity 105 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to support the described techniques. Each of these components may be in communication with one another (e.g., via one or more buses).

The receiver 710 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 705. In some examples, the receiver 710 may support obtaining information by receiving signals via one or more antennas. Additionally, or alternatively, the receiver 710 may support obtaining information by receiving signals via one or more wired (e.g., electrical, fiber optic) interfaces, wireless interfaces, or any combination thereof.

The transmitter 715 may provide a means for outputting (e.g., transmitting, providing, conveying, sending) information generated by other components of the device 705. For example, the transmitter 715 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 715 may support outputting information by transmitting signals via one or more antennas. Additionally, or alternatively, the transmitter 715 may support outputting information by transmitting signals via one or more wired (e.g., electrical, fiber optic) interfaces, wireless interfaces, or any combination thereof. In some examples, the transmitter 715 and the receiver 710 may be co-located in a transceiver, which may include or be coupled with a modem.

The device 705, or various components thereof, may be an example of means for performing various aspects of beam-selective paging message transmission as described herein. For example, the communications manager 720 may include an SSB outputting manager 725, a PEI outputting manager 730, a paging message outputting manager 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. The SSB outputting manager 725 is capable of, configured to, or operable to support a means for outputting, to a first UE, a synchronization signal block indicating for the UE to monitor a first transmission beam associated with a first paging early indication message, where the first paging early indication message is different from one or more second paging early indication messages associated with one or more second transmission beams. The PEI outputting manager 730 is capable of, configured to, or operable to support a means for outputting, via the first transmission beam, the first paging early indication message, where the first paging early indication message indicates a first MO of a PO associated with a first paging message. The paging message outputting manager 735 is capable of, configured to, or operable to support a means for outputting, via the first MO, the first paging message in accordance with the first paging early indication message.

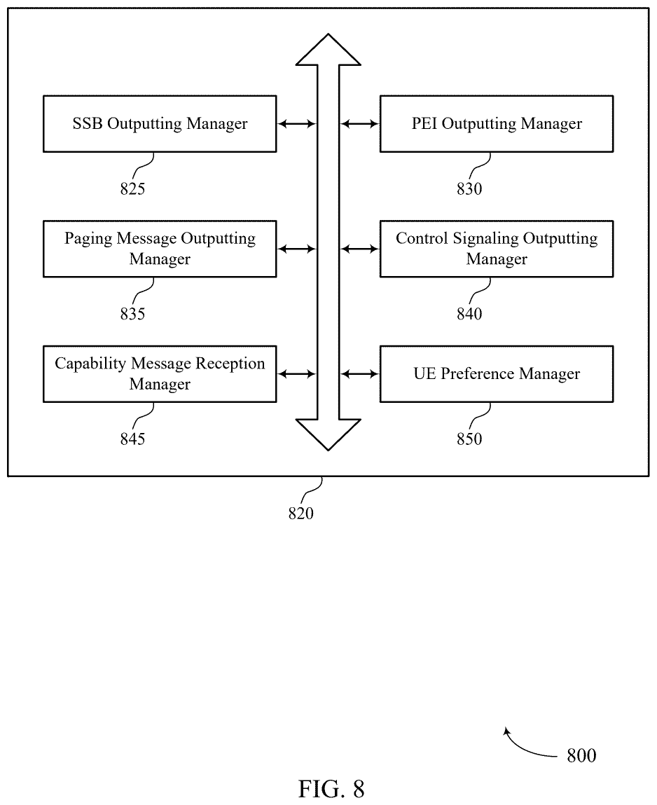

FIG. 8 shows a block diagram 800 of a communications manager 820 that supports beam-selective paging message transmission in accordance with one or more aspects of the present disclosure. The communications manager 820 may be an example of aspects of a communications manager 620, a communications manager 720, or both, as described herein. The communications manager 820, or various components thereof, may be an example of means for performing various aspects of beam-selective paging message transmission as described herein. For example, the communications manager 820 may include an SSB outputting manager 825, a PEI outputting manager 830, a paging message outputting manager 835, a control signaling outputting manager 840, a capability message reception manager 845, a UE preference manager 850, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 820 may support wireless communications in accordance with examples as disclosed herein. The SSB outputting manager 825 is capable of, configured to, or operable to support a means for outputting, to a first UE, a synchronization signal block indicating for the UE to monitor a first transmission beam associated with a first paging early indication message, where the first paging early indication message is different from one or more second paging early indication messages associated with one or more second transmission beams. The PEI outputting manager 830 is capable of, configured to, or operable to support a means for outputting, via the first transmission beam, the first paging early indication message, where the first paging early indication message indicates a first MO of a PO associated with a first paging message. The paging message outputting manager 835 is capable of, configured to, or operable to support a means for outputting, via the first MO, the first paging message in accordance with the first paging early indication message.

In some examples, the control signaling outputting manager 840 is capable of, configured to, or operable to support a means for outputting, to the UE, first control signaling indicating a location of the first MO in the PO, where outputting the first paging message is in accordance with the first control signaling.

In some examples, the capability message reception manager 845 is capable of, configured to, or operable to support a means for obtaining, from the UE, a capability message that indicates a first type of the UE. In some examples, the control signaling outputting manager 840 is capable of, configured to, or operable to support a means for outputting, to the UE, second control signaling indicating that the PO, the first MO, or both are associated with the first type of the UE, where a second PO, a second MO, or both are associated with a second type.

In some examples, the control signaling outputting manager 840 is capable of, configured to, or operable to support a means for outputting, to the UE, third control signaling indicating for the UE to monitor resources associated with the first type, the second type, or both based on the capability message.

In some examples, the UE preference manager 850 is capable of, configured to, or operable to support a means for obtaining, from the UE, signaling indicating a preference of the UE to monitor resources associated with the first type, the second type, or both.

In some examples, the first MO is dynamically associated with the synchronization signal block based on the first paging early indication message. In some examples, one or more additional MOs of the PO are not associated with one or more additional paging messages. In some examples, the first MO occurs earlier in time than the one or more additional MOs of the PO. In some examples, the PO is dynamically indicated via the first paging early indication message.

In some examples, the indication of the first MO includes an implicit indication based on a paging subgroup associated with the UE and a quantity of MOs indicated via the first paging early indication message. In some examples, the indication of the first MO includes an explicit indication based on a MO offset value indicated via the first paging early indication message. In some examples, the MO offset value is associated with a paging subgroup associated with the UE and a quantity of MOs indicated via the first paging early indication message.

In some examples, the first MO occurs later in time than one or more additional MOs of the PO that are not associated with one or more additional paging messages based on the MO offset value. In some examples, the first paging early indication message indicates an aggregation level associated with the first paging message, a position of a paging search space set associated with the first paging message, beam associated with the first paging message, a quasi co-location assumption associated with the first paging message, a quantity of repetitions associated with the first paging message, an associated synchronization signal block identifier associated with the first paging message, or any combination thereof.

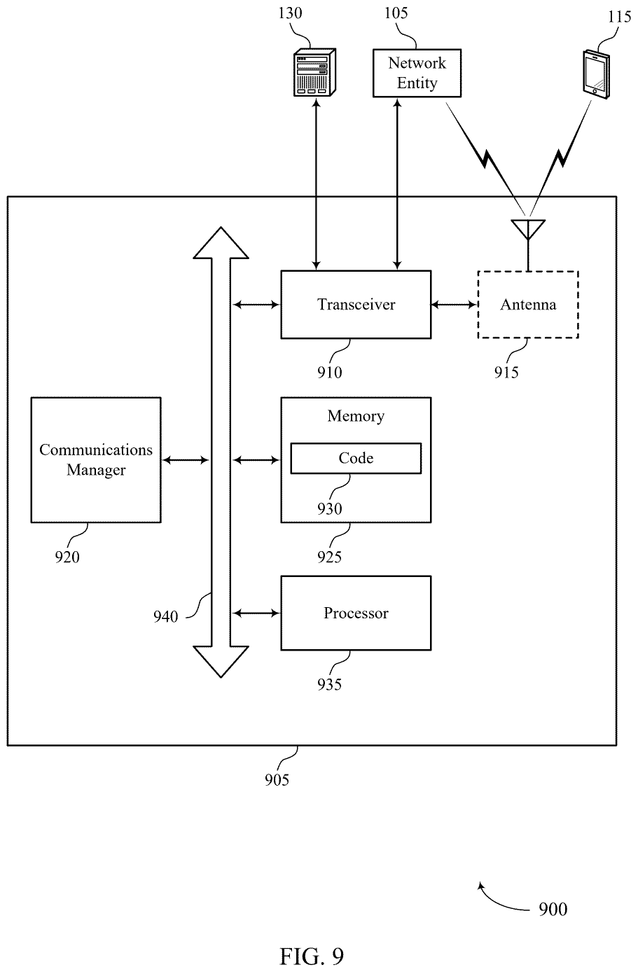

FIG. 9 shows a diagram of a system 900 including a device 905 that supports beam-selective paging message transmission in accordance with one or more aspects of the present disclosure. The device 905 may be an example of or include components of a device 605, a device 705, or a network entity 105 as described herein. The device 905 may communicate with other network devices or network equipment such as one or more of the network entities 105, UEs 115, or any combination thereof. The communications may include communications over one or more wired interfaces, over one or more wireless interfaces, or any combination thereof. The device 905 may include components that support outputting and obtaining communications, such as a communications manager 920, a transceiver 910, one or more antennas 915, at least one memory 925, code 930, and at least one processor 935. These components may be in electronic communication or otherwise coupled (e.g., operatively, communicatively, functionally, electronically, electrically) via one or more buses (e.g., a bus 940).

The transceiver 910 may support bi-directional communications via wired links, wireless links, or both as described herein. In some examples, the transceiver 910 may include a wired transceiver and may communicate bi-directionally with another wired transceiver. Additionally, or alternatively, in some examples, the transceiver 910 may include a wireless transceiver and may communicate bi-directionally with another wireless transceiver. In some examples, the device 905 may include one or more antennas 915, which may be capable of transmitting or receiving wireless transmissions (e.g., concurrently). The transceiver 910 may also include a modem to modulate signals, to provide the modulated signals for transmission (e.g., by one or more antennas 915, by a wired transmitter), to receive modulated signals (e.g., from one or more antennas 915, from a wired receiver), and to demodulate signals. In some implementations, the transceiver 910 may include one or more interfaces, such as one or more interfaces coupled with the one or more antennas 915 that are configured to support various receiving or obtaining operations, or one or more interfaces coupled with the one or more antennas 915 that are configured to support various transmitting or outputting operations, or a combination thereof. In some implementations, the transceiver 910 may include or be configured for coupling with one or more processors or one or more memory components that are operable to perform or support operations based on received or obtained information or signals, or to generate information or other signals for transmission or other outputting, or any combination thereof. In some implementations, the transceiver 910, or the transceiver 910 and the one or more antennas 915, or the transceiver 910 and the one or more antennas 915 and one or more processors or one or more memory components (e.g., the at least one processor 935, the at least one memory 925, or both), may be included in a chip or chip assembly that is installed in the device 905. In some examples, the transceiver 910 may be operable to support communications via one or more communications links (e.g., communication link(s) 125, backhaul communication link(s) 120, a midhaul communication link 162, a fronthaul communication link 168).

The at least one memory 925 may include RAM, ROM, or any combination thereof. The at least one memory 925 may store computer-readable, computer-executable, or processor-executable code, such as the code 930. The code 930 may include instructions that, when executed by one or more of the at least one processor 935, cause the device 905 to perform various functions described herein. The code 930 may be stored in a non-transitory computer-readable medium such as system memory or another type of memory. In some cases, the code 930 may not be directly executable by a processor of the at least one processor 935 but may cause a computer (e.g., when compiled and executed) to perform functions described herein. In some cases, the at least one memory 925 may include, among other things, a BIOS which may control basic hardware or software operation such as the interaction with peripheral components or devices. In some examples, the at least one processor 935 may include multiple processors and the at least one memory 925 may include multiple memories. One or more of the multiple processors may be coupled with one or more of the multiple memories which may, individually or collectively, be configured to perform various functions herein (for example, as part of a processing system).

The at least one processor 935 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 935 may be configured to operate a memory array using a memory controller. In some other cases, a memory controller may be integrated into one or more of the at least one processor 935. The at least one processor 935 may be configured to execute computer-readable instructions stored in a memory (e.g., one or more of the at least one memory 925) to cause the device 905 to perform various functions (e.g., functions or tasks supporting beam-selective paging message transmission). For example, the device 905 or a component of the device 905 may include at least one processor 935 and at least one memory 925 coupled with one or more of the at least one processor 935, the at least one processor 935 and the at least one memory 925 configured to perform various functions described herein. The at least one processor 935 may be an example of a cloud-computing platform (e.g., one or more physical nodes and supporting software such as operating systems, virtual machines, or container instances) that may host the functions (e.g., by executing code 930) to perform the functions of the device 905. The at least one processor 935 may be any one or more suitable processors capable of executing scripts or instructions of one or more software programs stored in the device 905 (such as within one or more of the at least one memory 925).

In some examples, the at least one processor 935 may include multiple processors and the at least one memory 925 may include multiple memories. One or more of the multiple processors may be coupled with one or more of the multiple memories, which may, individually or collectively, be configured to perform various functions herein. In some examples, the at least one processor 935 may be a component of a processing system, which may refer to a system (such as a series) of machines, circuitry (including, for example, one or both of processor circuitry (which may include the at least one processor 935) and memory circuitry (which may include the at least one memory 925)), or components, that receives or obtains inputs and processes the inputs to produce, generate, or obtain a set of outputs. The processing system may be configured to perform one or more of the functions described herein. For example, the at least one processor 935 or a processing system including the at least one processor 935 may be configured to, configurable to, or operable to cause the device 905 to perform one or more of the functions described herein. Further, as described herein, being “configured to,” being “configurable to,” and being “operable to” may be used interchangeably and may be associated with a capability, when executing code stored in the at least one memory 925 or otherwise, to perform one or more of the functions described herein.

In some examples, a bus 940 may support communications of (e.g., within) a protocol layer of a protocol stack. In some examples, a bus 940 may support communications associated with a logical channel of a protocol stack (e.g., between protocol layers of a protocol stack), which may include communications performed within a component of the device 905, or between different components of the device 905 that may be co-located or located in different locations (e.g., where the device 905 may refer to a system in which one or more of the communications manager 920, the transceiver 910, the at least one memory 925, the code 930, and the at least one processor 935 may be located in one of the different components or divided between different components).

In some examples, the communications manager 920 may manage aspects of communications with a core network 130 (e.g., via one or more wired or wireless backhaul links). For example, the communications manager 920 may manage the transfer of data communications for client devices, such as one or more UEs 115. In some examples, the communications manager 920 may manage communications with one or more other network entities 105, and may include a controller or scheduler for controlling communications with UEs 115 (e.g., in cooperation with the one or more other network devices). In some examples, the communications manager 920 may support an X2 interface within an LTE/LTE-A wireless communications network technology to provide communication between network entities 105.

The communications manager 920 may support wireless communications in accordance with examples as disclosed herein. For example, the communications manager 920 is capable of, configured to, or operable to support a means for outputting, to a first UE, a synchronization signal block indicating for the UE to monitor a first transmission beam associated with a first paging early indication message, where the first paging early indication message is different from one or more second paging early indication messages associated with one or more second transmission beams. The communications manager 920 is capable of, configured to, or operable to support a means for outputting, via the first transmission beam, the first paging early indication message, where the first paging early indication message indicates a first MO of a PO associated with a first paging message. The communications manager 920 is capable of, configured to, or operable to support a means for outputting, via the first MO, the first paging message in accordance with the first paging early indication message.

By including or configuring the communications manager 920 in accordance with examples as described herein, the device 905 may support techniques for dynamically associating paging resources with a paging message, which may enable reduced power consumption, more efficient utilization of communication resources, and improved coordination between devices.

In some examples, the communications manager 920 may be configured to perform various operations (e.g., receiving, obtaining, monitoring, outputting, transmitting) using or otherwise in cooperation with the transceiver 910, the one or more antennas 915 (e.g., where applicable), or any combination thereof. Although the communications manager 920 is illustrated as a separate component, in some examples, one or more functions described with reference to the communications manager 920 may be supported by or performed by the transceiver 910, one or more of the at least one processor 935, one or more of the at least one memory 925, the code 930, or any combination thereof (for example, by a processing system including at least a portion of the at least one processor 935, the at least one memory 925, the code 930, or any combination thereof). For example, the code 930 may include instructions executable by one or more of the at least one processor 935 to cause the device 905 to perform various aspects of beam-selective paging message transmission as described herein, or the at least one processor 935 and the at least one memory 925 may be otherwise configured to, individually or collectively, perform or support such operations.

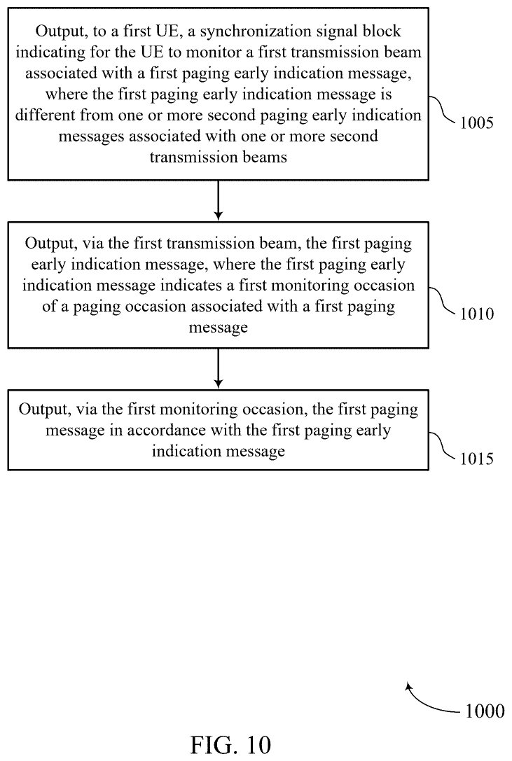

FIG. 10 shows a flowchart illustrating a method 1000 that supports beam-selective paging message transmission in accordance with one or more aspects of the present disclosure. The operations of the method 1000 may be implemented by a network entity or its components as described herein. For example, the operations of the method 1000 may be performed by a network entity as described with reference to FIGS. 1 through 9. In some examples, a network entity may execute a set of instructions to control the functional elements of the network entity to perform the described functions. Additionally, or alternatively, the network entity may perform aspects of the described functions using special-purpose hardware.

At 1005, the method may include outputting, to a first UE, a synchronization signal block indicating for the UE to monitor a first transmission beam associated with a first paging early indication message, where the first paging early indication message is different from one or more second paging early indication messages associated with one or more second transmission beams. The operations of 1005 may be performed in accordance with examples as disclosed herein. In some examples, aspects of the operations of 1005 may be performed by an SSB outputting manager 825 as described with reference to FIG. 8.

At 1010, the method may include outputting, via the first transmission beam, the first paging early indication message, where the first paging early indication message indicates a first MO of a PO associated with a first paging message. The operations of 1010 may be performed in accordance with examples as disclosed herein. In some examples, aspects of the operations of 1010 may be performed by a PEI outputting manager 830 as described with reference to FIG. 8.

At 1015, the method may include outputting, via the first MO, the first paging message in accordance with the first paging early indication message. The operations of 1015 may be performed in accordance with examples as disclosed herein. In some examples, aspects of the operations of 1015 may be performed by a paging message outputting manager 835 as described with reference to FIG. 8.

The following provides an overview of aspects of the present disclosure:
Aspect 1: A method for wireless communications by a network entity, comprising: outputting, to a first UE, a SSB indicating for the UE to monitor a first transmission beam associated with a first PEI message, wherein the first PEI message is different from one or more second PEI messages associated with one or more second transmission beams; outputting, via the first transmission beam, the first PEI message, wherein the first PEI message indicates a first MO of a PO associated with a first paging message; and outputting, via the first MO, the first paging message in accordance with the first PEI message.
Aspect 2: The method of aspect 1, further comprising: outputting, to the UE, first control signaling indicating a location of the first MO in the PO, wherein outputting the first paging message is in accordance with the first control signaling.
Aspect 3: The method of any of aspects 1 through 2, further comprising: obtaining, from the UE, a capability message that indicates a first type of the UE; and outputting, to the UE, second control signaling indicating that the PO, the first MO, or both are associated with the first type of the UE, wherein a second PO, a second MO, or both are associated with a second type.

Aspect 4: The method of aspect 3, further comprising: outputting, to the UE, third control signaling indicating for the UE to monitor resources associated with the first type, the second type, or both based at least in part on the capability message.

Aspect 5: The method of any of aspects 3 through 4, further comprising: obtaining, from the UE, signaling indicating a preference of the UE to monitor resources associated with the first type, the second type, or both.

Aspect 6: The method of any of aspects 1 through 5, wherein the first MO is dynamically associated with the SSB based at least in part on the first PEI message.

Aspect 7: The method of any of aspects 1 through 6, wherein one or more additional MOs of the PO are not associated with one or more additional paging messages.

Aspect 8: The method of aspect 7, wherein the first MO occurs earlier in time than the one or more additional MOs of the PO.

Aspect 9: The method of any of aspects 1 through 8, wherein the PO is dynamically indicated via the first PEI message.

Aspect 10: The method of any of aspects 1 through 9, wherein the indication of the first MO comprises an implicit indication based at least in part on a paging subgroup associated with the UE and a quantity of MOs indicated via the first PEI message.

Aspect 11: The method of any of aspects 1 through 10, wherein the indication of the first MO comprises an explicit indication based at least in part on a MO offset value indicated via the first PEI message.

Aspect 12: The method of aspect 11, wherein the MO offset value is associated with a paging subgroup associated with the UE and a quantity of MOs indicated via the first PEI message.

Aspect 13: The method of any of aspects 11 through 12, wherein the first MO occurs earlier in time than one or more additional MOs of the PO that are not associated with one or more additional paging messages based at least in part on the MO offset value.

Aspect 14: The method of any of aspects 11 through 13, wherein the first PEI message indicates an aggregation level associated with the first paging message, a position of a paging search space set associated with the first paging message, beam associated with the first paging message, a quasi co-location assumption associated with the first paging message, a quantity of repetitions associated with the first paging message, an associated SSB identifier associated with the first paging message, or any combination thereof.

Aspect 15: A network entity for wireless communications, comprising one or more memories storing processor-executable code, and one or more processors coupled with the one or more memories and individually or collectively operable to execute the code to cause the network entity to perform a method of any of aspects 1 through 14.

Aspect 16: A network entity for wireless communications, comprising at least one means for performing a method of any of aspects 1 through 14.

Aspect 17: A non-transitory computer-readable medium storing code for wireless communications, the code comprising instructions executable by one or more processors to perform a method of any of aspects 1 through 14.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A network entity, comprising:
one or more memories storing processor-executable code; and
one or more processors coupled with the one or more memories and individually or collectively operable to execute the code to cause the network entity to:
output, to a first user equipment (UE), a synchronization signal block indicating for the UE to monitor a first transmission beam associated with a first paging message, wherein the first paging message is different from one or more second paging messages associated with one or more second transmission beams; and
output, via the first transmission beam and via a first monitoring occasion of a paging occasion, the first paging message.

2. The network entity of claim 1, wherein the one or more processors are individually or collectively further operable to execute the code to cause the network entity to:
output, to the UE, first control signaling indicating a location of the first monitoring occasion in the paging occasion, wherein outputting the first paging message is in accordance with the first control signaling.

3. The network entity of claim 1, wherein the one or more processors are individually or collectively further operable to execute the code to cause the network entity to:
obtain, from the UE, a capability message that indicates a first type of the UE; and
output, to the UE, second control signaling indicating that the paging occasion, the first monitoring occasion, or both are associated with the first type of the UE, wherein a second paging occasion, a second monitoring occasion, or both are associated with a second type.

4. The network entity of claim 3, wherein the one or more processors are individually or collectively further operable to execute the code to cause the network entity to:
output, to the UE, third control signaling indicating for the UE to monitor resources associated with the first type, the second type, or both based at least in part on the capability message.

5. The network entity of claim 3, wherein the one or more processors are individually or collectively further operable to execute the code to cause the network entity to:
obtain, from the UE, signaling indicating a preference of the UE to monitor resources associated with the first type, the second type, or both.

6. The network entity of claim 1, wherein the one or more processors are individually or collectively further operable to execute the code to cause the network entity to:
output, via the first transmission beam, a first paging early indication message, wherein the first paging early indication message indicates the first monitoring occasion of the paging indication, and wherein receiving the first paging message via the first monitoring occasion is in accordance with the first paging early indication message.

7. The network entity of claim 6, wherein the first monitoring occasion is dynamically associated with the synchronization signal block based at least in part on the first paging early indication message.

8. The network entity of claim 6, wherein the paging occasion is dynamically indicated via the first paging early indication message.

9. The network entity of claim 6, wherein the indication of the first monitoring occasion comprises an implicit indication based at least in part on a paging subgroup associated with the UE and a quantity of monitoring occasions indicated via the first paging early indication message.

10. The network entity of claim 6, wherein the indication of the first monitoring occasion comprises an explicit indication based at least in part on a monitoring occasion offset value indicated via the first paging early indication message.

11. The network entity of claim 10, wherein the monitoring occasion offset value is associated with a paging subgroup associated with the UE and a quantity of monitoring occasions indicated via the first paging early indication message.

12. The network entity of claim 10, wherein the first monitoring occasion occurs later in time than one or more additional monitoring occasions of the paging occasion that are not associated with one or more additional paging messages based at least in part on the monitoring occasion offset value.

13. The network entity of claim 10, wherein the first paging early indication message indicates an aggregation level associated with the first paging message, a position of a paging search space set associated with the first paging message, beam associated with the first paging message, a quasi co-location assumption associated with the first paging message, a quantity of repetitions associated with the first paging message, an associated synchronization signal block identifier associated with the first paging message, or any combination thereof.

14. The network entity of claim 1, wherein one or more additional monitoring occasions of the paging occasion are not associated with one or more additional paging messages.

15. The network entity of claim 14, wherein the first monitoring occasion occurs earlier in time than the one or more additional monitoring occasions of the paging occasion.

16. A method for wireless communications by a network entity, comprising:
outputting, to a first user equipment (UE), a synchronization signal block indicating for the UE to monitor a first transmission beam associated with a first paging message, wherein the first paging message is different from one or more second paging messages associated with one or more second transmission beams; and
outputting, via the first transmission beam and via a first monitoring occasion of a paging occasion, the first paging message.

17. The method of claim 16, further comprising:
outputting, to the UE, first control signaling indicating a location of the first monitoring occasion in the paging occasion, wherein outputting the first paging message is in accordance with the first control signaling.

18. The method of claim 16, further comprising:
obtaining, from the UE, a capability message that indicates a first type of the UE; and
outputting, to the UE, second control signaling indicating that the paging occasion, the first monitoring occasion, or both are associated with the first type of the UE, wherein a second paging occasion, a second monitoring occasion, or both are associated with a second type.

19. The method of claim 18, further comprising:
outputting, to the UE, third control signaling indicating for the UE to monitor resources associated with the first type, the second type, or both based at least in part on the capability message.

20. A non-transitory computer-readable medium storing code for wireless communications, the code comprising instructions executable by one or more processors to:
output, to a first user equipment (UE), a synchronization signal block indicating for the UE to monitor a first transmission beam associated with a first paging message, wherein the first paging message is different from one or more second paging messages associated with one or more second transmission beams;
output, via the first transmission beam and via a first monitoring occasion of a paging occasion, the first paging message.
